(19) United States
(12) Patent Application Publication
(10) Pub. No.: US 2010/0176091 A1
(43) Pub. Date: Jul. 15, 2010

(54) ELECTRICAL SWITCHGEAR UNIT COMPRISING A COMPLEMENTARY ELECTRICAL FUNCTION

(75) Inventors: Jean-Yves Amblard, Le Gua (FR); Noël Le-Corre, Saint Hilaire du Touvet (FR); Luc Moreau, Saint Martin Le Vinoux (FR)

Correspondence Address: STEPTOE & JOHNSON LLP, 1330 CONNECTICUT AVENUE, N.W., WASHINGTON, DC, 20036, US

(73) Assignee: Schneider Electric Industries SAS, Rueil Malmaison (FR)

(21) Appl. No.: 12/602,704

(22) PCT Filed: Jun. 12, 2008
(86) PCT No.: PCT/FR08/00804

§ 371 Date: Dec. 2, 2009

(30) Foreign Application Priority Data
Jun. 29, 2007 (FR) 07/04685

(51) Int. Cl. H01H 33/02

(52) U.S. Cl. 218/149

(57) ABSTRACT

The present invention relates to an electrical switchgear unit designed to be fixed onto a fixing support and comprising at least one electrical switching module and at least one module housing a complementary electrical function, at least one of the complementary modules being situated next to at least one of the above-mentioned switching modules, the or each switching module comprising an arc extinguishing chamber. This unit is characterized in that the arc extinguishing chamber of the module situated facing the complementary module presents a cambered face towards the inside of said arc extinguishing chamber so as to create a space E,F inside said chamber enabling a part of the volume of the complementary module to be housed, and in that the ends of said arc extinguishing chamber encroach on the volume of the complementary module.

The present invention relates to an electrical switchgear unit designed to be fixed onto a fixing support and comprising at least one switching module and at least one module housing a complementary electrical function, at least one of the modules housing a complementary electrical function being situated next to at least one of the above-mentioned switching modules, the or each switching module comprising an arc extinguishing chamber.

The document EP 0948021 is known describing a multipole differential circuit breaker housed in a single case, a differential protection module surrounded on each side by two electrical switching modules each housing a circuit breaker pole-unit, the assembly being contained in dimensions corresponding to four basic modules. In this document, the switching compartments are of uniform width over their whole height. These uniform widths of the switching compartments prevent the size of the toroid from being able to be increased. This results in it not being possible to increase the performances of the unit without increasing the width of the unit.

The present invention overcomes these problems and proposes an electrical switchgear unit comprising a certain number of switching modules and at least one module performing a complementary electrical function, wherein either the rated current or the performances of the complementary function are increased while at the same time preserving the switching performances of the unit and without increasing the overall width of the unit.

For this purpose, the object of the present invention is to provide an electrical switchgear unit of the above-mentioned kind, this unit being characterized in that the arc extinguishing chamber of the module located facing the complementary module presents a cambered face towards the inside of said arc extinguishing chamber so as to create a space inside said arc extinguishing chamber enabling a part of the volume of the module housing the complementary function to be housed, and in that the ends of said arc extinguishing chamber encroach on the volume of the complementary module.

According to another feature, the or each of the arc extinguishing chambers comprises a stack of plates extending in a substantially parallel direction to one another, the edges of the plates of the above-mentioned arc extinguishing chamber, situated facing the complementary module, being situated in a plane cambered towards the inside of the corresponding arc extinguishing chamber.

According to another feature, the switching module(s) respectively house(s) the pole-unit(s) of a circuit breaker and the module housing the complementary function is a differential protection module.

According to a particular embodiment, the differential protection module comprises a toroid and the toroid is partially housed in the volume of the adjacent switching module(s).

According to another particular feature, this unit comprises a differential module surrounded on each side by a switching module housing a circuit breaker pole-unit, the two faces of the arc extinguishing chambers of the two switching modules situated on each side of the differential module having a shape that is cambered towards the inside of said arc extinguishing chamber.

According to another feature, the or each switching module comprising an electromagnetic coil, this unit is characterized in that the or each switching module comprises at least one wall comprising an offset so as to form two portions of modules of different widths, the width being the dimension of the unit measured parallel to the direction of alignment of the modules, the part of module presenting the smaller width housing the arc extinguishing chamber and the part of module presenting the larger width housing the coil, said coil presenting a larger diameter than the width of the corresponding arc extinguishing chamber.

According to another feature, the differential protection module comprises a toroid placed between two arc extinguishing chambers facing one another, and the axis of the toroid extends in a parallel direction to the axis of the coil(s).

But other advantages and features of the invention will become more clearly apparent from the following detailed description which refers to the accompanying drawings given for example purposes only and in which:

FIG. 1 is a partial cross-sectional view of a two-pole differential circuit breaker according to the invention along a plane parallel to the base of the apparatus,

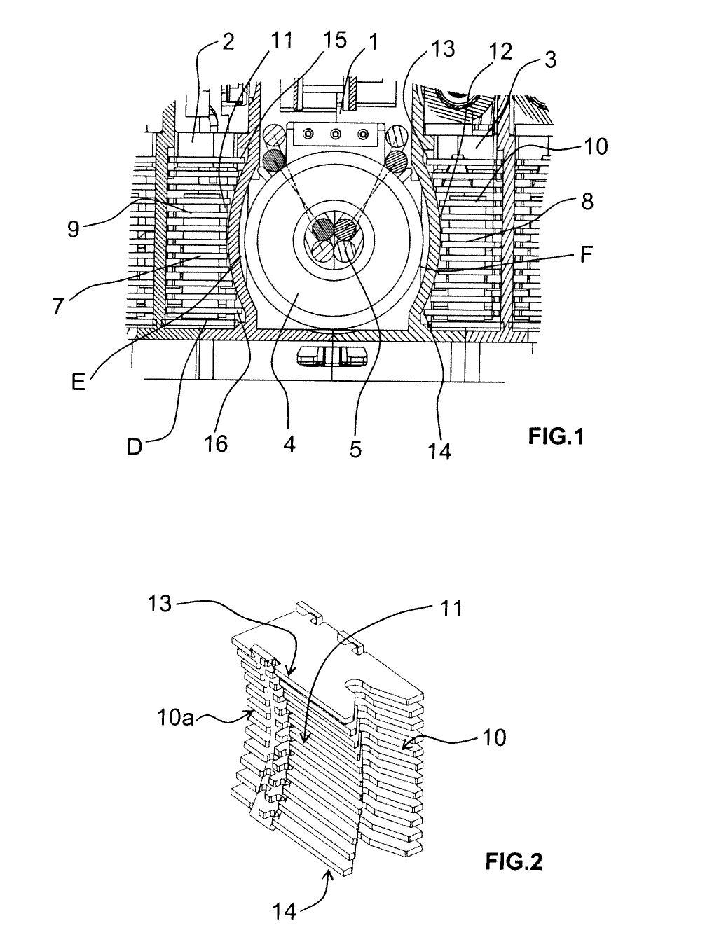

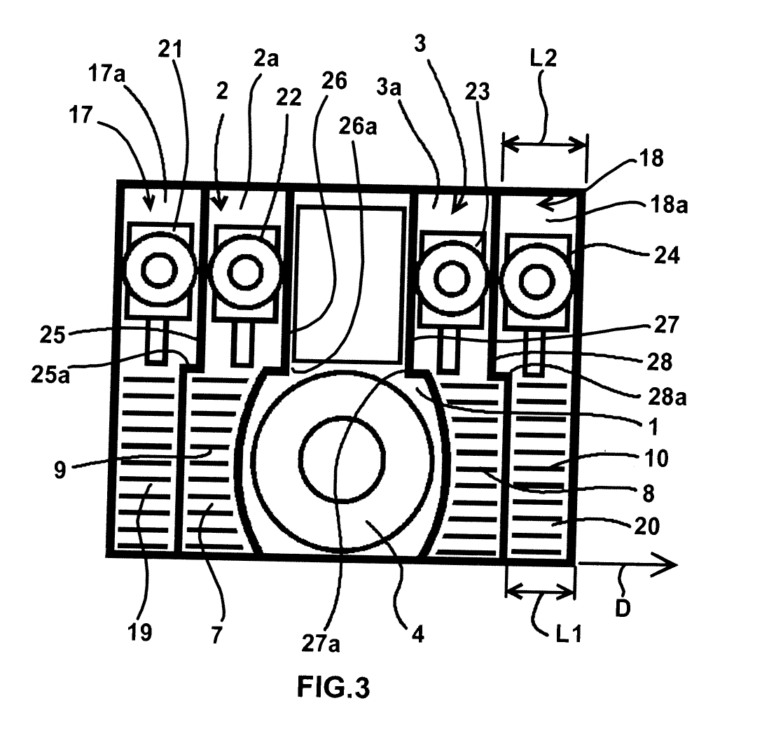

FIG. 2 is a perspective view illustrating a set of plates constituting an arc extinguishing chamber according to the invention, and

FIG. 3 is a schematic representation in plan view illustrating a multipole differential circuit breaker according to the invention according to a particular embodiment of the invention.

The inner part of a two-pole differential circuit breaker D comprising a differential module 1 surrounded by two switching modules 2,3 has been represented in FIG. 1. In a manner known as such, differential module 1 comprises a toroid 4 through which main conductors 5 pass, and the switching modules 2,3 each comprise an arc extinguishing chamber 7,8, each arc extinguishing chamber 7,8 comprising a set of juxtaposed plates 9,10 extending in a direction substantially parallel to one another and to the base of the unit.

According to the invention, faces 11,12 of arc extinguishing chambers 7,8 locating facing the toroid are cambered towards the inside of said arc extinguishing chambers. For this purpose, the width of the plates has been reduced in the centre of arc extinguishing chambers 7,8 and increases as the distance to the ends 13,14,15,16 of said chambers decreases. Edges 10a of the plates located facing the complementary module are thereby situated in a plane cambered towards the inside of the corresponding arc extinguishing chamber. This has enabled a space E,F to be created inside arc extinguishing chambers 7,8 to house a part of toroid 4, the dimensions of the latter having thereby been able to be increased. The reduction of the width of the plates in the central part of arc extinguishing chambers 7,8 is compensated by the increased width of the plates at ends 13 to 16 of chambers 7,8, thereby resulting in the electrical breaking performances not being modified.

The invention has thereby enabled an arc extinguishing chamber to be achieved enabling the toroid to encroach on the volume of the switching pole-units without penalising the breaking capacity, on the one hand by means of creation of an additional space to house the toroid the dimensions whereof have been increased, and on the other hand due to the increase of the width of the extinguishing chamber at the ends of said chamber. The toroid is surrounded by material of the chamber, the quantity of material being preserved so as to preserve the breaking capacity, this being achieved without increasing the width of the unit.

In FIG. 3, a multipole differential circuit breaker according to the invention comprises a differential protection module 1 surrounded on each side by two switching modules 2,3,17,18. Each switching module 2,3,17,18 comprises an arc extinguishing chamber 7,8,19,20 housing plates 9,10 arranged parallel to one another and an electromagnetic coil 22,23,21,24. Each part 2a,3a,17a,18a of switching module 2,3,17,18 housing coil 21 to 24 is offset with respect to the corresponding arc extinguishing chamber 7,8,19,20 so that each switching module 2,3,17,18 encroaches on the adjacent switching module or on the complementary module over a length substantially corresponding to that of the electro-magnetic coil. For this purpose, separating partitions 26,27,25,28 of switching modules 2,3,17,18 present an offset 26a,25a,28a,27a in the direction of complementary module 1, at the level of the separation between the arc extinguishing chamber and the coil housing, so as to form two portions of modules of different widths L1,L2, this width being measured parallel to the direction of alignment D of the modules. The part of module presenting the smaller width L1 houses the arc extinguishing chamber and the part of module presenting the larger width L2 houses the coil, said coil presenting a larger diameter than the width of the corresponding arc extinguishing chamber. This arrangement enables the cross-sections of the coil wires to be increased so as to reduce overheating by 20%.

This means that a wire of suitable cross-section for the targeted performances can be used and that the width of the unit is not increased. The performances of the magnetic protection devices are thereby increased while at the same time preserving the initial dimensions of the unit.

This arrangement is particularly advantageous in the case where the toroid is placed in such a way that its axis is parallel to the axis of the coils. This particular arrangement of the toroid does in fact enable the partitions to be offset so as to enlarge the space in which the coils are housed.

The invention applies advantageously to differential circuit breakers and in general manner to monoblock modular electrical switchgear units comprising a central or lateral complementary function such as an integrated remote control, an outlet gas recirculation system etc.

The invention is naturally not limited to the embodiments described and illustrated which have been given for example purposes only.

On the contrary, the invention extends to encompass all the technical equivalents of the means described as well as combinations thereof if the latter are achieved according to the spirit of the invention.

1. An electrical switchgear unit designed to be fixed onto a fixing support, said unit comprising at least one switching module and at least one module housing a complementary electrical function, called complementary module, at least one of the complementary modules being situated next to at least one of the above-mentioned switching modules, the or each switching module comprising an arc extinguishing chamber, characterized in that the arc extinguishing chamber of at least one switching module located facing at least one complementary module presents a cambered face towards the inside of said arc extinguishing chamber so as to create a space E,F inside said arc extinguishing chamber enabling a part of the volume of the complementary module to be housed, and in that the ends of said arc extinguishing chamber encroach on the volume of the complementary module.

2. The electrical switchgear unit according to claim 1, the or each of the arc extinguishing chambers comprising a stack of plates extending in a direction substantially parallel to one another, characterized in that the edges of the plates of the above-mentioned arc extinguishing chamber, situated facing the complementary module, are situated in a plane cambered towards the inside of the corresponding arc extinguishing chamber

3. The electrical switchgear unit according to claim 1, characterized in that the switching module(s) respectively house(s) the pole-units of a circuit breaker, and that the complementary module is a differential protection module.

4. The electrical switchgear unit according to claim 3, characterized in that the differential protection module comprises a toroid and that the toroid is partially housed in the volume of the adjacent switching module(s).

5. The electrical switchgear unit according to claim 1, characterized in that it comprises a differential module surrounded on each side by a switching module housing a circuit breaker pole-unit, the two faces of the two arc extinguishing chambers situated on each side of the differential module having a shape that is cambered towards the inside of said arc extinguishing chamber.

6. The electrical switchgear unit according to claim 1, the or each switching module comprising an electromagnetic coil, characterized in that the or each switching module comprises at least one wall comprising an offset so as to form two portions of modules of different widths L1,L2, the width being the dimension of the unit measured parallel to the direction D of alignment of the modules, the part of module presenting the smaller width L1 housing the arc extinguishing chamber and the part of module presenting the larger width L2 housing the coil, said coil presenting a larger diameter than the width of the corresponding arc extinguishing chamber.

7. The electrical switchgear unit according to claim 6, characterized in that the differential protection module comprises a toroid placed between two facing arc extinguishing chambers, and that the axis of the toroid extends in a parallel direction to the axis of the coil(s).
